(19) United States
(12) Patent Application Publication
(10) Pub. No.: US 2015/0357657 A1
(43) Pub. Date: Dec. 10, 2015

(54) CONTROL AND HEATING OF FUEL CELL STACK COOLANT THERMAL MASS

(71) Applicant: Ford Global Technologies, LLC, Dearborn, MI (US)

(72) Inventors: Brian Gillespey, Brownstown, MI (US); William F. Sanderson, Commerce Twp., MI (US); Craig Michael Mathie, White Lake Twp., MI (US)

(21) Appl. No.: 14/296,815

(22) Filed: Jun. 5, 2014

(51) Int. Cl. H01M 8/04

(52) U.S. Cl. CPC H01M 8/04029

(57) ABSTRACT

A fuel cell system is includes a fuel cell stack with a cooling line arrangement configured to pass coolant through the stack, a pump configured to move the coolant through the arrangement, and at least one controller. The controller is programmed to, in response to a start-up event for the stack at an ambient temperature less than a first threshold value, initiate operation of the stack and to prevent activation of the pump in order to promote static flow conditions within the arrangement.

### TECHNICAL FIELD

This disclosure relates to systems and methods for controlling and heating the coolant thermal mass of a fuel cell stack during a freeze start and normal operation.

### BACKGROUND

When starting a fuel cell system at sub-freezing temperatures as low as −30° C. to −40° C. in electric vehicles for example, it may be important to minimize ice formation. Water produced by the fuel cell electrochemical reaction can quickly solidify to ice, leading to accelerated catalyst and material degradation, and hampered startup. Also, it is desirable to allow the fuel cell to increase in temperature since the power output of the fuel cell is generally low at cold operating temperatures.

### SUMMARY

A fuel cell system includes a fuel cell stack, a cooling line arrangement configured to pass coolant through the stack, a pump configured to move the coolant through the arrangement, and at least one controller programmed to, in response to a start-up of the stack at an ambient temperature less than a first threshold value, prevent activation of the pump to promote static flow conditions within the arrangement to heat up the stack.

A fuel cell system includes a fuel cell stack, a cooling line arrangement configured to pass coolant through the stack, a pump configured to move the coolant through the arrangement, and at least one controller programmed to, in response to a start-up of the stack at an ambient temperature less than a first threshold value, operate the pump at a flow rate less than an operating target value to slow heat transfer from the stack to the coolant and to increase a rate at which the stack heats up.

A fuel cell system includes a fuel cell stack, a cooling line arrangement including valving and configured to pass coolant through the stack, a pump configured to move the coolant through the arrangement, and at least one controller programmed to, in response to a start-up of the stack at an ambient temperature less than a first threshold value, configure the valving to form a recirculation path for the stack from portions of the arrangement to fluidly isolate the stack from a rest of the arrangement and to reduce a mass of the coolant within the arrangement heated during the start-up.

### BRIEF DESCRIPTION OF THE DRAWINGS

FIG. 1 is a schematic illustration of a fuel cell system with a controller for pump activation;

FIGS. 2A and 2B are schematic illustrations of a fuel cell system with two three-way valves in the cooling line arrangement;

FIG. 3 is a schematic illustration of a fuel cell system with a pump in the recirculation path; and

FIG. 4 is a schematic illustration of a fuel cell system including one heater for both the recirculation path and the rest of the cooling line arrangement.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The coolant that circulates through a fuel cell stack is part of the system thermal mass and will act as a heat sink as it circulates through the stack thus slowing the stack heating and power production. Typical fuel cell cooling systems have a large volume of coolant contained in the vehicle cooling system. This larger volume of coolant is needed to effectively cool the fuel cell system when operated at normal power output. The thermal mass of the cooling system, however, may impede the heating of the system at sub-freezing temperatures.

Certain embodiments described herein may solve the problem of a slow and difficult start in cold climates due to the large thermal mass of the coolant fluid. The coolant loop for a fuel cell system typically includes a pump to provide the required flow rate and potentially a heater to heat the coolant fluid. The heater can also act as an electrical load for the fuel cell stack. An electrical load for the fuel cell stack may be required when the fuel cell stack is operating at low power output during startup conditions. The electrical load could also be provided by a component such as a high voltage battery or a high voltage electric motor. The fuel cell is operated at low voltage to generate heat under cold start conditions, and a load is needed for the current generated.

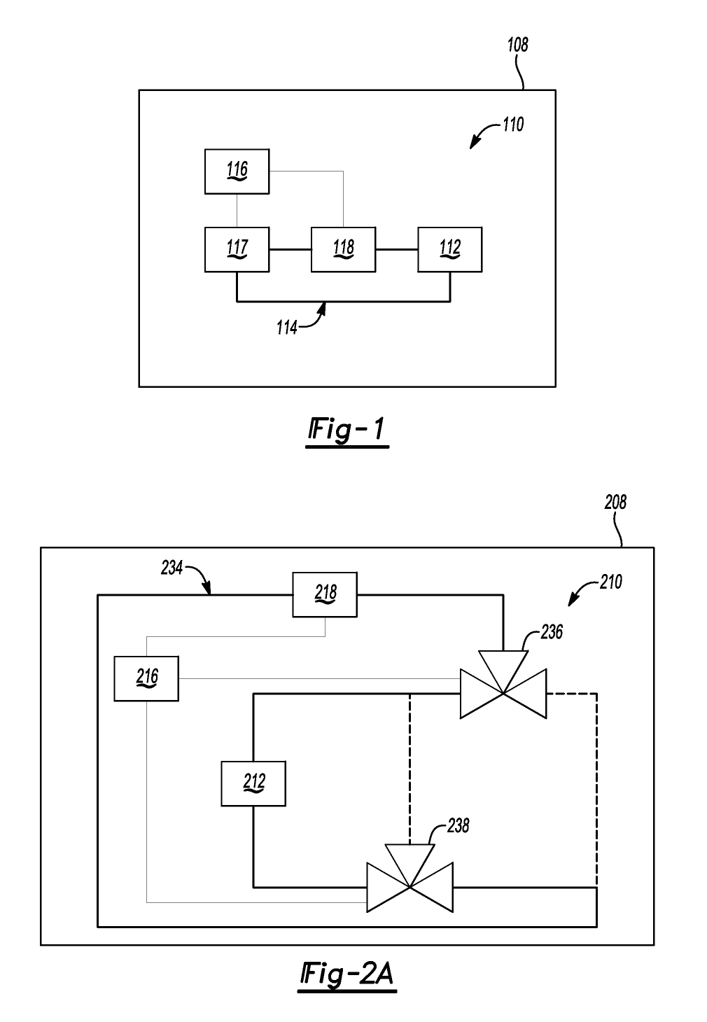

With reference to FIG. 1, an embodiment is shown in which a vehicle 108 includes a fuel cell system 110. The fuel cell system 110 includes a fuel cell stack 112, a cooling line arrangement 114 (shown in thick line) configured to pass coolant through the stack 112, and a controller 116. (The cooling line arrangement 114 may also be configured to pass through a radiator or to move heat to or from other components. Suitable valves may be used to bypass the radiator, etc.) A heater 117, in certain embodiments, may be provided in the cooling line arrangement 114. A pump 118 may be used to move coolant through the cooling line arrangement 114. The stack 112, heater 117, and pump 118 are in communication with or under the control of the controller 116 (as shown in thin line). Although this embodiment uses a controller 116, a regulator or other sensor with output can be used.

Upon a start-up event for the fuel cell stack 112, if the ambient temperature is less than a first threshold value, the controller 116 may be programmed to respond by initiating the operation of the stack 112 and to prevent activation of the pump 118. This results in a static flow condition within the cooling arrangement 114, which allows the stack 112 to warm due to its own heat generation without being cooled by the cooling arrangement 114. This static flow condition continues while the temperature of the stack 112 is less than a second temperature threshold. The controller 116, or additional controller, may be programmed to activate the pump 118 in response to the temperature of the stack 112 exceeding the second temperature threshold or in response to the inlet temperature or the outlet temperature associated with the stack 112. At this time, either the fuel cell stack 112 has reached a temperature that may reliably result in stable operation, or another component in the cooling loop, such as a heater, needs a flow of coolant for its own operation. The first threshold value, for example, may be less than −25° C. or more preferably less than −5° C. The second threshold value, for example, may be 0° C. or more preferably greater than 5° C. When activated, the pump 18 may, for example, provide a constant flow of 0.5 liters per minute at a minimum, or it may be pulsed to provide intermittent flow.

In another embodiment, a recirculation path is established from a portion of the cooling arrangement. The recirculation path isolates stack coolant from the coolant in the remainder of the system. The recirculation path also presents the opportunity to minimize the thermal mass of coolant contained therein, which enables the stack to retain more of the heat it generates when desired, such as in freezing conditions. This separate recirculation path may operate at reduced flow rates or in a no flow condition to further reduce heat loss from the stack during a cold start. For reduced flow rates in the recirculation path, the flow rate may be controlled by the pump or by using variable valving. The valves may be used to variably blend the coolant from the two loops together to avoid thermal shock. Two, three-way valves may connect the recirculation path to the rest of the cooling arrangement during normal operation to ensure sufficient heat rejection capability and flow rates to remove the heat that is generated by the fuel cell.

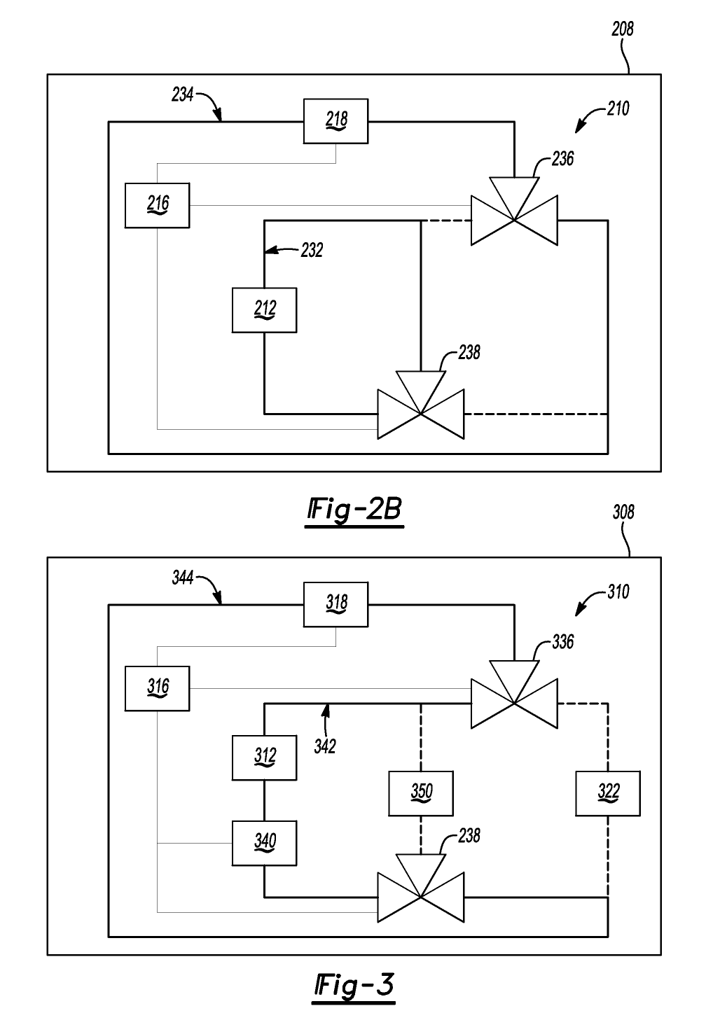

With reference to FIGS. 2A, a vehicle 208 includes a fuel cell system 210. The fuel cell system 210 includes a fuel cell stack 212, a pump 218, and a cooling line arrangement 234. The cooling line arrangement 234 includes a first three-way valve 236 and a second three-way valve 238. A controller 216 is configured to actuate the three-way valves 236, 238 and the pump 218. A separate controller, however, may be used to control the pump 218 or valves 236, 238. The valves 236, 238 in FIG. 3A are shown actuated such that there is one coolant loop for the entire fuel cell system 210. (The dashed line indicates the absence of flow.)

With reference to FIG. 2B, the controller 216 may, in response to a startup event of the fuel cell stack 212, configure the valves 236, 238 to form a recirculation path 232 for the stack 212 isolated from a rest of the cooling line arrangement 234 to reduce the mass of fluid to be heated during startup. In other embodiments, the valve 236 alone (thus omitting the valve 238) may be configured to form a recirculation path 232 for the stack 212 fluidly isolated from a rest of the cooling line arrangement 234.

In another embodiment, a fuel cell system comprises a fuel cell stack and a cooling line arrangement with a pump and valve. The cooling line arrangement is configured to pass coolant through the stack, and at least one controller is provided and programmed to, in response to a startup event for the stack at an ambient temperature less than a first threshold value, initiate operation of the stack and activation of the pump to promote flow conditions less than, for example, 3 liters per minute. Other reference operating target values, however, may be used. (Operating target values, as the name suggests, may be those values achieved during normal operation of the system. Thus, the system initially intentionally operates with flows less than normal.) There may be one controller or more than one controller. The controller or controllers may be further programmed to, in response to the startup event, configure a valve to isolate the stack from the coolant flow while having coolant flow in the rest of the cooling line arrangement.

With reference to FIG. 3, a vehicle 308 includes a fuel cell system 310. The fuel cell system 310 includes a fuel cell stack 312, a pump 318, and a cooling line arrangement 344. A second pump 340 is arranged in recirculation path 342 so that the flow rate of the coolant in the recirculation path can be controlled and reduced relative to the flow rate of the coolant in the rest of the cooling line arrangement 344. A controller 316 is configured to actuate the three-way valves 336, 338 and the pumps 318, 340. The second pump 340 may be operated independently from the pump 318. A heater 322 (possibly under the control of the controller 316) may be used to heat the coolant fluid in the recirculation path 342 or in the rest of the line arrangement 344. If used, the flow rate to the heater 322 should be maintained at a level sufficient to allow the heater 322 to operate. The heater 322 may serve as an electrical load so that the fuel cell stack 312 can be operated at a low voltage to generate heat for warm-up. The amount of heat generated while operating at low voltage may be 1 to 30 kW.

In certain arrangements, an additional heater 350 (also possibly under the control of the controller 316) or other electrical load may be provided in the recirculation path 342 to increase the rate of heating during a cold start. The heater 350 may be positioned close to an input of the fuel cell stack 312 to minimize coolant heat loss during cold start as the coolant flows from the heater 350 to the fuel cell stack 312. The heaters 322, 350 are shown in those portions of the cooling line arrangement 344 that may be bypassed. One or both, of course, may also be positioned in those portions that cannot be bypassed—such as, for example, the area at which the arrowed line from 342 points.

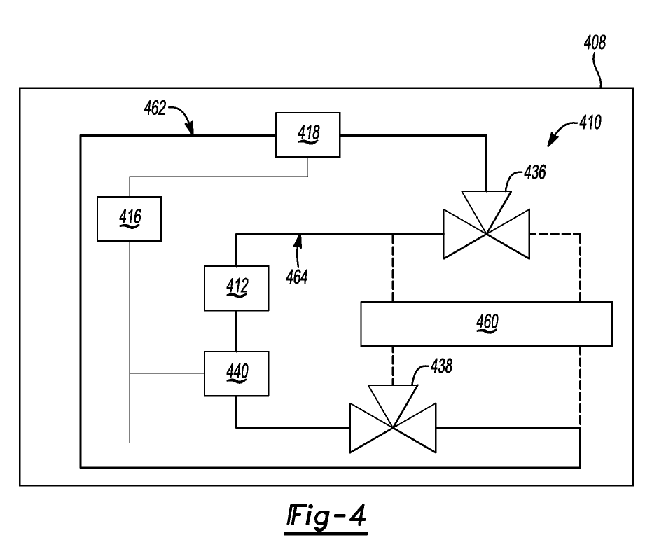

With reference to FIG. 4, a vehicle 408 includes a fuel cell system 410. The fuel cell system 410 includes a fuel cell stack 412, a pump 418, and a cooling line arrangement 462. A second pump 440 is disposed within a recirculation path 464 formed from the cooling line arrangement 462 so that the flow rate of the coolant in the recirculation path 464 can be controlled and reduced relative to the flow rate of the coolant in the rest of the cooling line arrangement 462. A controller 416 is configured to actuate three-way valves 436, 438 and the pumps 418, 440 to achieve the various configurations described herein. The second pump 440 may be operated independently from the pump 418. A heater 460 may be disposed within the cooling line arrangement 462 such that it provides heat to both the coolant in the recirculation path 464 and the coolant in those portions of the cooling line arrangement 462 not in the recirculation path 464. Other arrangements are also possible.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A fuel cell system comprising:
a fuel cell stack;
a cooling line arrangement configured to pass coolant through the stack;
a pump configured to move the coolant through the arrangement; and
at least one controller programmed to, in response to a start-up of the stack at an ambient temperature less than a first threshold value, prevent activation of the pump to promote static flow conditions within the arrangement to heat up the stack.

2. The fuel cell system of claim 1, wherein the cooling line arrangement includes valving, wherein the at least one controller is further programmed to, in response to the start-up, configure the valving to form a recirculation path for the stack from portions of the arrangement to reduce a mass of the coolant within the arrangement heated during the start-up, and wherein the pump is disposed within the recirculation path.

3. The fuel cell system of claim 2 further comprising another pump configured to move the coolant through the arrangement and disposed outside of the recirculation path.

4. The fuel cell system of claim 2 further comprising a heater disposed within the recirculation path.

5. The fuel cell system of claim 1, wherein the at least one controller is further programmed to, in response to a temperature of the stack exceeding a second threshold value, activate the pump.

6. The fuel cell system of claim 5, wherein the at least one controller is further programmed to pulse the pump to limit thermal shock to the stack.

7. The fuel cell system of claim 1 further comprising a heater disposed within the cooling line arrangement.

8. A fuel cell system comprising:
a fuel cell stack;
a cooling line arrangement configured to pass coolant through the stack;
a pump configured to move the coolant through the arrangement; and
at least one controller programmed to, in response to a start-up of the stack at an ambient temperature less than a first threshold value, run the pump at a flow rate less than an operating target value to slow heat transfer from the stack to the coolant and to increase a rate at which the stack heats up.

9. The fuel cell system of claim 8, wherein the cooling line arrangement includes valving, wherein the at least one controller is further programmed to, in response to the start-up, configure the valving to form a recirculation path for the stack from portions of the arrangement to reduce a mass of the coolant within the arrangement heated during the start-up.

10. The fuel cell system of claim 8, wherein the at least one controller is further programmed to, in response to a temperature of the stack exceeding a second threshold value, cause the flow rate to exceed the operating target value to cool the stack.

11. The fuel cell system of claim 8 further comprising a heater disposed within the cooling line arrangement.

12. A fuel cell system comprising:
a fuel cell stack;
a cooling line arrangement including valving and configured to pass coolant through the stack;
a pump configured to move the coolant through the arrangement; and
at least one controller programmed to, in response to a start-up of the stack at an ambient temperature less than a first threshold value, configure the valving to form a recirculation path for the stack from portions of the arrangement to fluidly isolate the stack from a rest of the arrangement and to reduce a mass of the coolant within the arrangement heated during the start-up.

13. The fuel cell system of claim 12, wherein the at least one controller is further programmed to, during the start-up, prevent activation of the pump to promote static flow conditions within the recirculation path to heat up the stack.

14. The fuel cell system of claim 12, wherein the at least one controller is further programmed to, during the start-up, operate the pump at a flow rate less than an operating target value to slow heat transfer from the stack to the coolant to increase a rate at which the stack heats up.

15. The fuel cell system of claim 14, wherein the at least one controller is further programmed to, in response to a temperature of the stack exceeding a second threshold value, operate the pump at a flow rate greater than the operating target value to cool the stack.

16. The fuel cell system of claim 12, further comprising a heater disposed within the cooling line arrangement.
